(19) United States
(12) Patent Application Publication
(10) Pub. No.: US 2009/0234753 A1
(43) Pub. Date: Sep. 17, 2009

(54) AGENT-BASED CUSTOMIZED ONLINE SHOPPING

(75) Inventor: Norman X. SHI, Los Altos, CA (US)

Correspondence Address: YAHOO C/O MOFO PALO ALTO, 755 PAGE MILL ROAD, PALO ALTO, CA, 94304, US

(73) Assignee: YAHOO! INC., Sunnyvale, CA (US)

(21) Appl. No.: 12/049,857

(22) Filed: Mar. 17, 2008

(51) Int. Cl. G06Q 30/00

(52) U.S. Cl. 705/27

(57) ABSTRACT

A method of online shopping for generating a sale of customized merchandise based on user choices of an access group is provided. The method includes receiving, from an agent, an agent-defined template including customizable options for at least one merchandise item. After receiving the agent-defined template, the method includes receiving the access group identifying a plurality of users from the agent, and generating access information for the access group for accessing the agent-defined template. The access information allows each user of the access group to make choices based on the customizable options included in the agent-defined template.

### BACKGROUND OF THE INVENTION

Online, or Internet-based, shopping is an increasingly popular form of shopping. Today, it is common for merchants to maintain websites allowing customers to buy goods or services online.

For personal online shopping, e.g., one customer is selecting and purchasing products, the online shopping mechanism is reasonably straight-forward. For example, a merchant's online shopping website allows a customer to access the site, browse and view the available products, make choices according to associated specifications of the chosen product, and purchase the product. This mechanism works well because, for personal online shopping, an individual choice is just considered.

However, in the business-to-business market, such an online shopping mechanism lacks essential functionality. When purchasing items for a corporation or another organization, it is often necessary to allow others within the organization to review or approve a purchase request.

Therefore, it is useful to allow multiple customers to add or subtract items to an order before the purchase is complete. Currently, there are sharable online shopping carts that allow multiple users to add an item into a single shopping cart. This mechanism allows certain users to maintain control over the contents of the cart. For example, a shopping cart may be shared and a group of users may add items to the cart, but only one user is given the authority to make changes and/or to conclude the purchase.

However, if a large group has a need to purchase a semi-customizable item, such as an item that may have personalized associated specifications for each member of the group, organizing such a purchase is burdensome and time consuming for the organizer. The organizer would need to specify the constraints of the order and gather each individual choice from the group of people placing the order. Furthermore, the organizer may need to individually ask certain people for their choices since there may be a restriction on who is allowed to place an order.

Therefore, an online shopping method for generating a sale of customized merchandise based on user choices of a group of users is desired.

### BRIEF SUMMARY OF THE INVENTION

In accordance with embodiments of the present invention, a method of online shopping for generating a sale of customized merchandise based on user choices of an access group is provided. The method includes receiving, from an agent, an agent-defined template including customizable options for at least one merchandise item. After receiving the agent-defined template, the method includes receiving the access group identifying a plurality of users from the agent, and generating access information for the access group for accessing the agent-defined template. The access information allows each user of the access group to make choices based on the customizable options included in the agent-defined template.

In accordance with other embodiments of the present invention, a computer-readable medium comprising instructions for generating a sale of customized merchandise based on user choices of an access group, implemented by a processor, is provided. The instructions for a processor for performing a method. The method includes receiving, from an agent, an agent-defined template including customizable options for at least one merchandise item. After receiving the agent-defined template, the method includes receiving the access group identifying a plurality of users from the agent, and generating access information for the access group for accessing the agent-defined template. The access information allows each user of the access group to make choices based on the customizable options included in the agent-defined template.

Furthermore, in accordance with other embodiments of the present invention, an apparatus for generating a sale of customized merchandise based on user choices of an access group is provided. The apparatus includes logic for receiving an agent-defined template including customizable options for at least one merchandise item. The apparatus further includes logic for storing the agent-defined template. The agent-defined template is associated with access information. Logic for generating access information for the access group, the access group defined by the agent is included in the apparatus. The access information allows access to the agent-defined template. Furthermore, the apparatus includes logic for receiving user choices based on the customizable options included in the agent-defined template from at least one user of the access group.

Other features and aspects of the invention will become apparent from the following detailed description, taken in conjunction with the accompanying drawings which illustrate, by way of example, the features in accordance with embodiments of the invention. The summary is not intended to limit the scope of the invention.

### BRIEF DESCRIPTION OF THE DRAWINGS

FIG. 1 illustrates a flowchart of a method for generating a sale of customized merchandise based on user choices of an access group according to embodiments of the invention;

FIG. 2 illustrates a method of customizing orders of t-shirts for a group of users according to embodiments of the invention;

FIG. 3 illustrates a system for generating a sale of customized merchandise based on user choices of an access group according to embodiments of the invention; and

FIG. 4 illustrates a block diagram of a computing system according to embodiments of the invention.

In the following description, reference is made to the accompanying drawings which form a part thereof, and which illustrate several embodiments of the present invention. It is understood that other embodiments may be utilized and structural and operational changes may be made without departing from the scope of the present invention. The use of the same reference symbols in different drawings indicates similar or identical items.

### DETAILED DESCRIPTION OF THE INVENTION

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown.

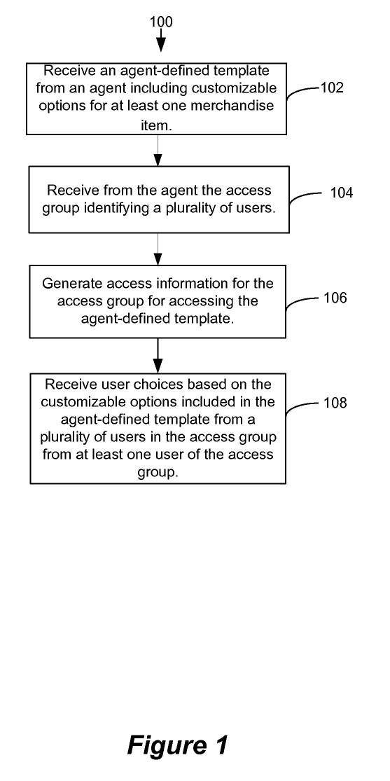

FIG. 1 illustrates a flowchart of a method for generating a sale of customized merchandise based on user choices of an access group according to embodiments of the invention. Method 100 shows the server first receives an agent-defined template from an agent 102. The agent defined template includes customizable options for at least one merchandise item. The customizable options may include, but is not limited to, budget, choice of images, and choice of colors, for example. In 104, the access group identifying a plurality of users is received. The plurality of users are the group of users the agent has defined to be allowed to access the agent-defined template in order to place an order. The agent may provide e-mail addresses of the users of the access group, for example.

In 106, access information is generated for the access group for accessing the agent-defined template. The access information may be a hyperlink, or a password, for example. The access information is used by the user that receives it to access the agent-defined template in order to pick their choices and place their order. The access information may be sent to the users in the access group in an e-mail, for example.

A user accesses the agent-defined template, and customizes their personalized order according to the options laid out in the agent-defined template. The user choices based on the customizable options included in the agent-defined template are received from a plurality of users in the access group from at least one user of the access group in 108.

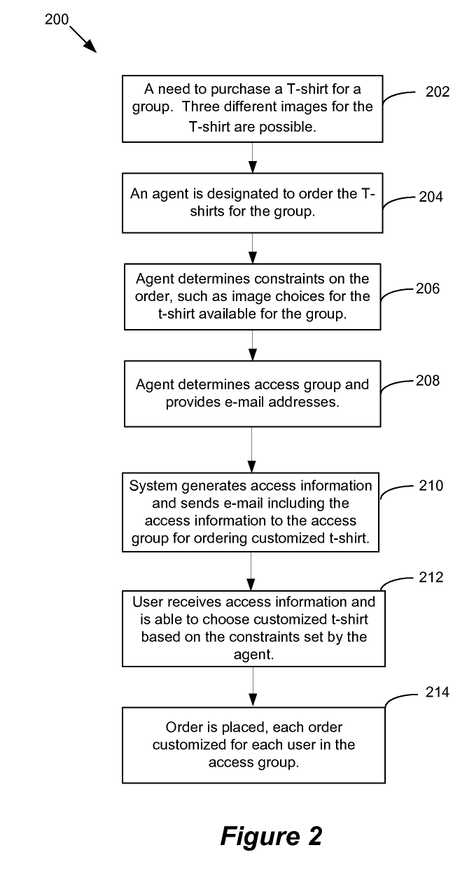

An example of how the method of FIG. 1 may be implemented is shown in FIG. 2. FIG. 2 illustrates a method of customizing orders of t-shirts for a group of users according to embodiments of the invention in 202. In this example, an agent is given the task of ordering t-shirts for a group in 204. The t-shirt may have one of three images, which each user may choose. Each user may also choose a t-shirt size, for example. In 206, the agent determines the constraints of the order, such as the image choices for the t-shirt that are available to the group. The image choices may be from an external source, such as Flickr, for example. The constraints may also include a specific type of t-shirt. However, the constraints may be a broad constraint, such as setting a budget range and allowing all products up to a certain price. Constraints may also include colors or specific products. The agent also determines the access group, or the group of users that will be allowed to access the agent-defined template for placing an order in 208. The agent may provide e-mail addresses of the users for determining the access group.

After the access group is defined, access information is generated and sends an e-mail including the access information. The access information may be an embedded hyperlink in the e-mail that allows the recipient of the e-mail, a user in the access group, to access the agent-defined template for ordering a t-shirt, including the options defined by the template.

When a user of the access group receives the access information, the user is able to choose a t-shirt according to his own preferences in 212. In other words, the user is able to make choices based on the constraints defined by the agent. After a user finishes customizing their t-shirt, the agent may be notified via email, for example. It may also be possible for a notification to be sent to the agent when all users of the access group have customized their t-shirt.

Finally, the order may be placed when each order has been customized for each user in the access group in 214.

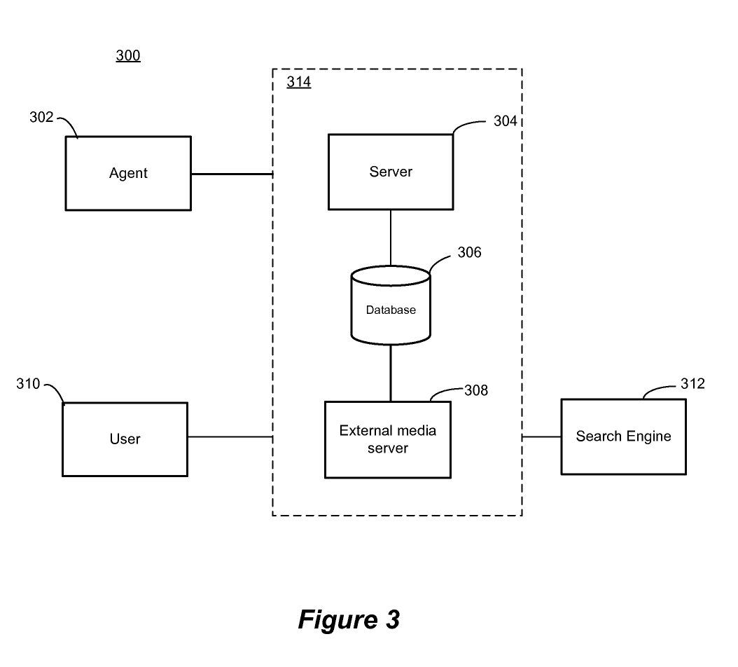

FIG. 3 illustrates a system for generating a sale of customized merchandise based on user choices of an access group according to embodiments of the invention. An agent at a client 302 accesses the system 314 in order to define the merchandise item for customizing. The system 314 may include a server 304, a database 306, and an external media server 308.

An agent at client 302 may define an agent-defined template at server 304 by accessing customizable merchandise options or media used for the merchandise item from external media server 308.

For example, the agent may set constraints, defined in the agent-defined template, to allow users of the access group to order one of five images available on an online photo sharing site, such as Flickr, as the external media server. The agent-defined template includes the constraints on the order defined by the agent 302. The agent-defined template is stored in a database 306.

The agent at the client 302 also defines a group of users as an access group. The access group includes the users that are allowed to shop for the merchandise item defined by the agent-defined template. The server 304 generates access information, such as a key, password, or link, that is sent to each user defined in the access group. The database 306 may be associated with an external media server 308. The access information is sent from system 314 to users of the access group. The access information allows a user 310 to access the system 314, including the external media server 308 with the constraints set by the agent-defined template stored in database 306, so that each user of the access group may personally customize the merchandise item.

Furthermore, the external media server may also be associated with a search engine 312. The search engine 312 may use the agent-defined template in database 306 as a query to return the media options to the user 310.

While aspects of the invention, including the above described systems and methods, are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

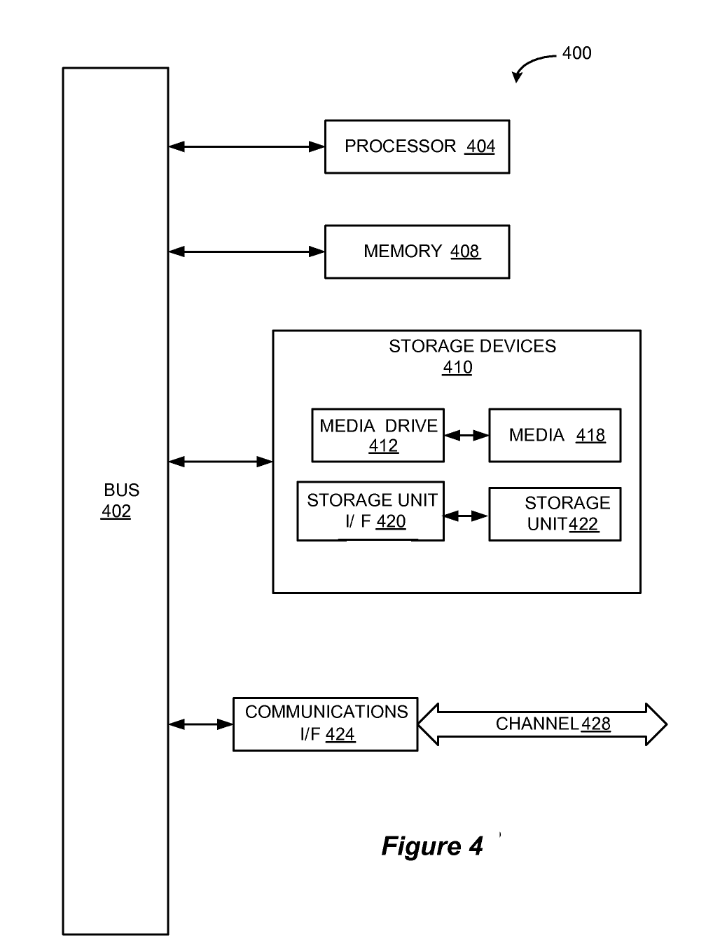

FIG. 4 illustrates an exemplary computing system 400 that may be employed to implement processing functionality for various aspects of the invention (e.g., as a server device, client device, database, presence platform, combinations thereof, and so on). Those skilled in the relevant art will also recognize how to implement the invention using other computer systems or architectures. Computing system 400 may represent, for example, a desktop, mainframe, server, client, or any other type of special or general purpose computing device as may be desirable or appropriate for a given application or environment. Computing system 400 can include one or more processors, such as a processor 404. Processor 404 can be implemented using a general or special purpose processing engine such as, for example, a microprocessor, microcontroller or other control logic. In this example, processor 404 is connected to a bus 402 or other communication medium.

Computing system 400 can also include a main memory 408, for example random access memory (RAM) or other dynamic memory, for storing information and instructions to be executed by processor 404. Main memory 408 also may be used for storing temporary variables or other intermediate information during execution of instructions to be executed by processor 404. Computing system 400 may likewise include a read only memory (“ROM”) or other static storage device coupled to bus 402 for storing static information and instructions for processor 404.

The computing system 400 may also include information storage mechanism 410, which may include, for example, a media drive 412 and a removable storage interface 420. The media drive 412 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 418 may include, for example, a hard disk, floppy disk, magnetic tape, optical disk, CD or DVD, or other fixed or removable medium that is read by and written to by media drive 414. As these examples illustrate, the storage media 418 may include a computer-readable storage medium having stored therein particular computer software or data.

In alternative embodiments, information storage mechanism 410 may include other similar instrumentalities for allowing computer programs or other instructions or data to be loaded into computing system 400. Such instrumentalities may include, for example, a removable storage unit 422 and an interface 420, such as a program cartridge and cartridge interface, a removable memory (for example, a flash memory or other removable memory module) and memory slot, and other removable storage units 422 and interfaces 420 that allow software and data to be transferred from the removable storage unit 418 to computing system 400.

Computing system 400 can also include a communications interface 424. Communications interface 424 can be used to allow software and data to be transferred between computing system 400 and external devices. Examples of communications interface 424 can include a modem, a network interface (such as an Ethernet or other NIC card), a communications port (such as for example, a USB port), a PCMCIA slot and card, etc. Software and data transferred via communications interface 424 are in the form of signals which can be electronic, electromagnetic, optical, or other signals capable of being received by communications interface 424. These signals are provided to communications interface 424 via a channel 428. This channel 428 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 408, storage device 418, storage unit 422, or signal(s) on channel 428. These and other forms of computer-readable media may be involved in providing one or more sequences of one or more instructions to processor 404 for execution. Such instructions, generally referred to as “computer program code” (which may be grouped in the form of computer programs or other groupings), when executed, enable the computing system 400 to perform features or functions of embodiments of the present invention.

In an embodiment where the elements are implemented using software, the software may be stored in a computer-readable medium and loaded into computing system 400 using, for example, removable storage drive 414, drive 412 or communications interface 424. The control logic (in this example, software instructions or computer program code), when executed by the processor 404, causes the processor 404 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

1. A computer-implementable method of online shopping for generating a sale of customized merchandise based on user choices of an access group, the method comprising:
receiving, from an agent, an agent-defined template including customizable options for at least one merchandise item, wherein the customizable options include at least one media query for an external media server, wherein the at least one media query dynamically generates available media choices provided from the external media server;
receiving, from the agent, the access group identifying a plurality of users;
generating access information for the access group for accessing the agent-defined template; and
receiving user choices based on the customizable options included in the agent-defined template from the at least one user of the access group, wherein the user choices include a media choice based on the available media choices generated by the at least one media query.

2. The method of claim 1, further comprising dynamically generating a search query based on the agent-defined template in response to the at least one user of the access group accessing the access information.

3. The method of claim 1, further comprising generating a status update of user choices for the agent.

4. The method of claim 1, wherein the access information is encoded in an HTML email.

5. The method of claim 4, wherein the access information is encoded in a link to a website.

6. The method of claim 1, further comprising receiving, from an agent, budget information for the at least one merchandise item.

7. The method of claim 1, wherein the access information is a password.

8. A computer-readable medium encoded with executable instructions, implementable by a processor, the executable instructions for:
receiving, from an agent, an agent-defined template including customizable options for at least one merchandise item, wherein the customizable options include at least one media query for an external media server, wherein the at least one media query dynamically generates available media choices provided from the external media server;
receiving, from the agent, the access group identifying a plurality of users;
generating access information for the access group for accessing the agent-defined template; and
receiving user choices based on the customizable options included in the agent-defined template from the at least one user of the access group, wherein the user choices include a media choice based on the available media choices generated by the at least one media query.

9. The computer-readable medium of claim 8, further comprising instructions for dynamically generating a search query based on the agent-defined template in response to the at least one user of the access group accessing the access information.

10. The computer-readable medium of claim 8, further comprising instructions for generating a status update of user choices for the agent.

11. The computer-readable medium of claim 8, wherein the access information is encoded in an HTML email.

12. The computer-readable medium of claim 11, wherein the access information is encoded in a link to a website.

13. The computer-readable medium of claim 8, further comprising instructions for receiving, from an agent, budget information for the at least one merchandise item.

14. The computer-readable medium of claim 8, wherein the access information is a password.

15. An apparatus for generating a sale of customized merchandise based on user choices of an access group, the apparatus comprising:
a processor for:
receiving an agent-defined template including customizable options for at least one merchandise item, wherein the customizable options include at least one media query for an external media server, wherein the at least one media query dynamically generates available media choices provided from the external media server,
generating the access information for the access group, the access group defined by the agent, wherein the access information allows access to the agent-defined template, and
receiving user choices based on the customizable options included in the agent-defined template from a plurality of users in the access group from at least one user of the access group, wherein the user choices include a media choice based on the available media choices generated by the at least one media query; and
a memory for storing the agent-defined template, wherein the agent-defined template is associated with access information.

16. The apparatus of claim 15, wherein the logic for storing the agent-defined template is a database.
